(19) United States
(12) Patent Application Publication
(10) Pub. No.: US 2006/0285146 A1
(43) Pub. Date: Dec. 21, 2006

(54) Apparatus and method to select and print emulation by pages

(75) Inventor: Seung-sik Yang, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/471,507

(22) Filed: Jun. 21, 2006

(30) Foreign Application Priority Data
Jun. 21, 2005 (KR) 2005-53608

(51) Int. Cl. G06F 3/12

(52) U.S. Cl. 358/1.13

(57) ABSTRACT

An apparatus and method to select and print emulation by pages. The apparatus includes a storage unit to store an enhanced meta file (EMF) of a whole document and data obtained by measuring the performance of a printer controller; and a controller to select the emulation to be printed based on the complexity of the EMF stored in the storage unit and the data obtained by measuring the performance of the printer controller. When a printer driver produces emulation of print data of a document, emulation to be printed is selected by analyzing the complexity of pages of the document from an EMF stored in a storage unit and the speed of a printer controller calculated from data obtained by measuring the performance of the printer controller, so that users can print the document under the optimum printing speed and printing quality.

### CROSS-REFERENCE TO RELATED APPLICATIONS

This application claims the benefit of Korean Patent Application No. 2005-53608, filed on Jun. 21, 2005, in the Korean Intellectual Property Office, the disclosure of which is incorporated herein in its entirety by reference.

### BACKGROUND OF THE INVENTION

1. Field of the Invention

The present general inventive concept relates to an apparatus and method to select and print emulation by pages, and more particularly, to an apparatus and method to select emulation to be printed by analyzing the complexity of pages of a document to be printed and the speed of a print controller.

2. Description of the Related Art

FIG. 1 is a flowchart of a method of selecting and printing emulation in a conventional printer driver. Referring to FIG. 1, a user prepares for a document using a host application (operation 100) and opens a print menu to print the document (operation 110). The user selects a desired printer driver from the print menu (operation 120) and presses a print button (operation 130). If the user presses the print button, the printer driver creates a print command language for the emulation (operation 140). When the printer driver is selected in operation 120, printer control language (PCL) 6, PostScript (PS), or graphical device interface (GDI) is selected as the emulation. If the printer driver creates the print command language, the emulation in a firmware of a printer analyzes the print command language (operation 150). If the print command language is analyzed by the emulation, the document is printed on a paper after it is rendered (operation 160).

It is the main function of the conventional printer driver to convert Path, a bitmap, and a font into a command language such as PCL, PS, etc. according to a Windows GDI function. The firmware of the printer analyzes the command language created by the conventional printer driver, renders the analyzed command language, and produces an image to be printed in real time by a printer engine.

In a case where the document prepared by the user is very complex, the conventional printer driver can create several tens of thousands or several hundreds of thousands of complex command languages. Since processing a vector graphic using the command language such as PCL or PS is much more precise than converting the vector graphic into a GDI type image, PCL emulation or PS emulation is advantageous to GDI emulation in terms of printing quality. A printer having a good performance can process several hundreds of thousands of complex command languages promptly, whereas a bad printer requires several minutes through several tens of minutes in processing several hundreds of thousands of complex command languages, causing user inconvenience.

The conventional printer driver analyzes the Path, the bitmap, or the font according to the Windows GDI function, processes data, and converts data into the print command language. PCL emulation and PS emulation are excellent in a printing quality since they process vector graphics as functions and express very precise graphics. However, since PCL emulation and PS emulation occupy a large portion of a CPU of the printer to express vector graphics, they are inferior to GDI emulation in terms of a printing speed.

A GDI printer driver renders the Path, the bitmap, or the font into an image according to the Windows GDI function and transfers the image to a host printer to be directly printed, thereby being excellent in the printing speed. However, since GDI emulation processes vector graphics as images, it is inferior to PCL emulation and PS emulation in terms of the printing quality. With regard to a font printing, since PCL emulation can use a device font embedded in the printer and support a variety of true type fonts, it is far superior to and faster than GDI emulation in printing a document.

Conventionally, when diverse documents prepared by a user are printed by a PCL or GDI printer driver at a time, the user is satisfied with the printing quality of the PCL printer driver and the printing speed of the GDI printer driver. However, a user is not satisfied with the printing speed of the PCL printer driver and the printing quality of the GDI printer driver.

A printer having a good performance can obtain a fast printing speed and the optimum printing quality using the PCL driver. A printer having a bad performance can obtain a fast printing speed using the GDI driver. However, since the PCL driver or the GDI driver is conventionally determined regardless of the performance of a printer, a user cannot be satisfied with the printing speed and the printing quality at the same time.

### SUMMARY OF THE INVENTION

The present general inventive concept provides an apparatus and method to select emulation to be printed by analyzing the complexity of pages of a document from an enhanced meta file (EMF) stored in a storage unit and the speed of a printer controller calculated from data obtained by measuring the performance of the printer controller when a printer driver produces the emulation of print data of the document in order to solve problems of a good printing speed and a bad printing quality, or a good printing quality and a bad printing speed which are caused by a continuous printing using an initially established emulation.

Additional aspects and advantages of the present general inventive concept will be set forth in part in the description which follows and, in part, will be obvious from the description, or may be learned by practice of the general inventive concept.

The foregoing and/or other aspects and utilities of the present are achieved by providing an apparatus to select and print emulation by pages, the apparatus including: a storage unit to store an enhanced meta file (EMF) of a whole document and data obtained by measuring the performance of a printer controller, and a controller to select the emulation to be printed based on a complexity of the EMF stored in the storage unit and the data obtained by measuring the performance of the printer controller.

The controller may calculate the complexity of each of the pages of the document.

The apparatus may further include: a communication interfacer to transmit and/or receive the data obtained by measuring the performance of the printer controller and performing a bidirectional communication with the printer controller.

The controller may include: a page analyzer to analyze graphical device interface (GDI) functions included in each of the pages of the document from the EMF stored in the storage unit and to evaluate the complexity of each of the pages.

The controller may include: a controller performance calculator to calculate the speed of the printer controller from the data obtained by measuring the performance of the printer controller.

The controller performance calculator may calculate the speed of the printer controller from data including time required for the printer controller to receive a printer control language (PCL) 6 command to express a vector graphic, and to complete executing the PCL 6 command by a predetermined frequency that is received by the communication interfacer.

The controller may include: an emulation selector to select the emulation to be printed based on the analysis obtained by the page analyzer and the controller performance calculator.

In a case where the complexity of each of the pages is lower than a predetermined first reference value, the emulation selector may select PCL emulation or PostScript (PS) emulation. In a case where the complexity of each of the pages is higher than the predetermined first reference value, the emulation selector may select PCL emulation or PS emulation if the speed of the printer controller is higher than a predetermined second reference value, and the emulation selector may select GDI emulation if the speed of the printer controller is lower than the predetermined second reference value.

The foregoing and/or other aspects and utilities of the present general inventive concept may also be achieved by providing a method of selecting and printing emulation by pages, the method including calculating a complexity of a document from an EMF of the whole document and selecting emulation to be printed based on the calculated complexity of each of pages and data obtained by measuring the performance of a printer controller.

In the calculating of the complexity, the complexity of each of pages of the document may be evaluated.

The method may further include: before the selecting of emulation, calculating the speed of the printer controller from the data obtained by measuring the performance of the printer controller.

In the calculating of the complexity, the complexity of each of the pages may be evaluated by analyzing GDI functions included in each of the pages of the document from the EMF.

The speed of the printer controller may be calculated from data including time required for the printer controller to receive a PCL 6 command to express a vector graphic, and complete executing the PCL 6 command by a predetermined frequency that is received by a communication interfacer.

The data obtained by measuring the performance of the printer controller may be transmitted/received and a bidirectional communication with the printer controller is performed.

In the selecting of emulation, in a case where the complexity of each of the pages is lower than a predetermined first reference value, PCL emulation or PS emulation may be selected. In a case where the complexity of each of the pages is higher than the predetermined first reference value, PCL emulation or PS emulation may be selected if the speed of the printer controller is higher than a predetermined second reference value, and GDI emulation may be selected if the speed of the printer controller is lower than the predetermined second reference value.

The foregoing and/or other aspects and utilities of the present general inventive concept may also be achieved by providing a computer readable recording medium having embodied thereon a computer program for a method of selecting and printing emulation by pages, the method including calculating the complexity of a document from an EMF of the whole document, and selecting emulation to be printed based on the calculated complexity of each of pages and data obtained by measuring the performance of a printer controller.

An apparatus to select and print emulation by pages, including a controller to receive information on an enhanced meta file (EMF) of a whole document and data obtained by measuring performance of a printer controller to be used in the printing, and to select the emulation to be printed base on a complexity of the EMF received and the data obtained by measuring performance of a printer controller.

A method of selecting and printing emulation by pages, the method including determining a complexity of a document from an enhanced meta file (EMF) of the whole document and selecting emulation to be printed based on the determined complexity of each of pages and data obtained by measuring the performance of a printer controller.

A computer readable recording medium having embodied thereon a computer program for the method of selecting and printing emulation by pages, the method including determining a complexity of a document from an enhanced meta file (EMF) of the whole document and selecting emulation to be printed based on the determined complexity of each of pages and data obtained by measuring the performance of a printer controller.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart of a method of selecting and printing emulation in a conventional printer driver;

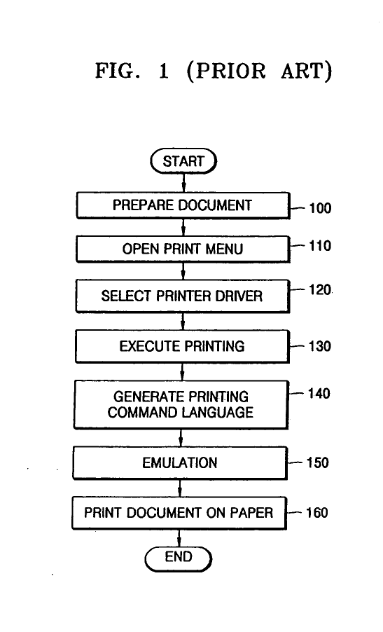

FIG. 2 is a block diagram of the constitution of an apparatus to select and print emulation by pages according to an embodiment of the present general inventive concept; and

FIG. 3 is a flowchart of a method of selecting and printing emulation by pages according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

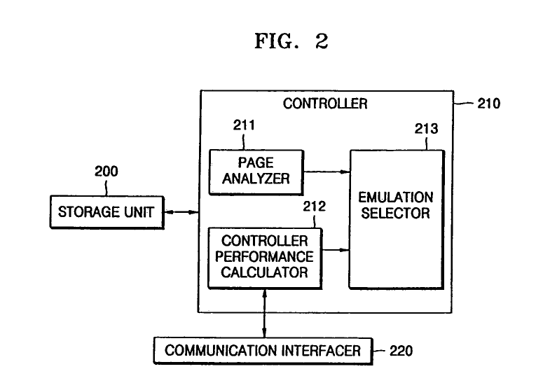

FIG. 2 is a block diagram of the constitution of an apparatus to select and print emulation by pages according to an embodiment of the present general inventive concept. Referring to FIG. 2, the apparatus includes a storage unit 200, a controller 210, and a communication interfacer 220.

The storage unit 200 can store an enhanced meta file (EMF) of a whole document and data obtained by measuring the performance of a printer controller. The EMF indicates Windows graphical device interface (GDI) functions generated by preparing a document in a host application.

The controller 210 can select the emulation to be printed by analyzing a complexity of pages of the document from the EMF stored in the storage unit 200 and the speed of the printer controller calculated from the data obtained by measuring the performance of the printer controller.

The controller 210 can include a page analyzer 211, a controller performance calculator 212, and an emulation selector 213.

The page analyzer 211 can analyze GDI functions included in each of the pages of the document from the EMF stored in the storage unit 200, and can evaluate the complexity of each of the pages according to an analysis of frequencies (number of times) in which a vector graphic GDI function is called by the pages.

The controller performance calculator 212 can calculate the speed of the printer controller from the data obtained by measuring the performance of the printer controller. The controller performance calculator 212 can calculate the speed of the printer controller from data including time required for the printer controller to receive a printer control language (PCL) 6 command to express a vector graphic and to complete executing the PCL 6 command by the determined frequencies (number of times) in which the vector graphic is received by the communication interfacer 220.

The emulation selector 213 can select the emulation to be printed based on the analysis obtained by the page analyzer 211 and the controller performance calculator 212. The emulation selector 213 can select PCL emulation or PostScript (PS) emulation if the complexity of each of the pages is lower than a predetermined first reference value. In a case of a complex document having many vector graphics as a result of the analysis, the emulation selector 213 can evaluate whether the printer controller has a high performance. If the printer controller has the high performance, since the high performance of the printer controller does not greatly delay the printing speed, the emulation selector 213 can generate a PCL 6 command language. Since users have a different standard for the complexity, in a case where a frequency in which the GDI vector function is called by pages is higher than the first reference value, it is determined to be a complex document. The first reference value is determined to be a complexity value desired by users.

If the complexity of each of the pages is higher than the predetermined first reference value, the emulation selector 213 can determine whether the speed of the printer controller is higher than a predetermined second reference value.

If the printer controller has a high performance, the emulation selector 213 can select PCL emulation or PS emulation. If the printer controller has a high performance, since the high performance of the printer controller does not greatly delay the printing speed, the emulation selector 213 can generate the PCL 6 command language.

If the speed of the printer controller is lower than the predetermined second reference value, the emulation selector 213 can select GDI emulation. In a case where the printer controller does not have a high performance and has many vector graphics, the emulation selector 213 can generate a GDI command language so as to prevent the printing speed from being delayed even if a printing quality is deteriorated. Since users have a different standard for a printing speed, the second reference value can be satisfied with the standard for the printing speed desired by users.

The communication interfacer 220 can transmit and/or receive the data obtained by measuring the performance of the printer controller. The communication interfacer 220 can perform a bidirectional communication with the printer controller.

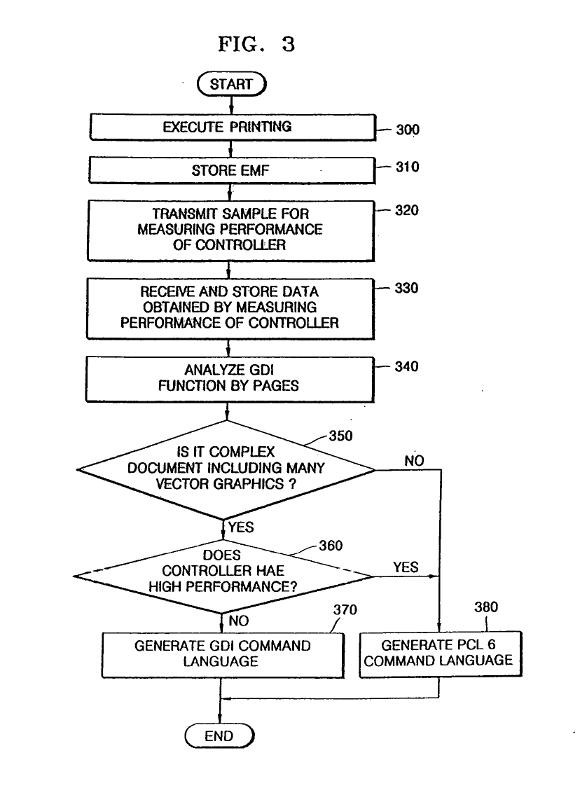

FIG. 3 is a flowchart of a method of selecting and printing emulation by pages according to an embodiment of the present general inventive concept. The method will now be described with reference to FIG. 2.

Referring to FIGS. 2 and 3, a user executes a print command (operation 300), transmits print data of a document to be printed to a printer driver, and an EMF of the whole document is stored in the storage unit 200 according to a control signal of the controller 210 (operation 310).

The controller performance calculator 212 transmits a sample for measuring the performance of a printer controller to a printer via the communication interfacer 220 (oepration 320). Time required for the printer controller to receive a PCL 6 command to express a vector graphic to a printer, and to complete executing the PCL 6 command by a predetermined frequency, is received by the communication interfacer 220 and is stored in the storage unit 200 (operation 330).

If data are completely collected to select the emulation, GDI functions called by pages are analyzed using the EMF stored in the storage unit 200 (operation 340).

As a result of analyzing the GDI functions, if the document to be printed is not a complex document including many vector graphics (operation 350), the PCL 6 command is generated (operation 380) since a printing speed is not greatly affected.

If the document to be printed is a complex document including many vector graphics, it is evaluated whether the printer controller has a high performance (operation 360). If the printer controller is evaluated to have the high performance, since the high performance of the printer controller does not greatly delay the printing speed even if the document includes many vector graphics, the PCL 6 command is generated (operation 380).

In a case where the printer controller does not have the high performance and has many vector graphics, a GDI command language is generated so as to prevent the printing speed from being greatly delayed even if a printing quality is deteriorated (operation 370).

The present general inventive concept can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves.

According to the present general inventive concept, when a printer driver produces emulation of print data of a document, emulation to be printed is selected by analyzing the complexity of pages of the document from an EMF stored in a storage unit and the speed of a printer controller calculated from data obtained by measuring the performance of the printer controller, so that users can print the document under the optimum printing speed and printing quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to select and print emulation by pages, the apparatus comprising:
a storage unit to store an enhanced meta file (EMF) of a whole document and data obtained by measuring the performance of a printer controller; and
a controller to select the emulation to be printed based on a complexity of the EMF stored in the storage unit and the data obtained by measuring the performance of the printer controller.

2. The apparatus of claim 1, wherein the controller calculates the complexity of each of pages of the document.

3. The apparatus of claim 1, further comprising: a communication interfacer transmit and/or receive the data obtained by measuring the performance of the printer controller and to perform a bidirectional communication with the printer controller.

4. The apparatus of claim 3, wherein the controller comprises:
a page analyzer to analyze graphical device interface (GDI) functions included in each of the pages of the document from the EMF stored in the storage unit and to evaluate the complexity of each of the pages.

5. The apparatus of claim 4, wherein the controller comprises:
a controller performance calculator to calculate the speed of the printer controller from the data obtained by measuring the performance of the printer controller.

6. The apparatus of claim 5, wherein the controller performance calculator calculates the speed of the printer controller from data including time required for the printer controller to receive a printer control language (PCL) 6 command for expressing a vector graphic, and to complete executing the PCL 6 command by a predetermined frequency that is received by the communication interfacer.

7. The apparatus of claim 5, wherein the controller comprises:
an emulation selector to select the emulation to be printed based on the analysis obtained by the page analyzer and the controller performance calculator.

8. The apparatus of claim 5, wherein,
in a case where the complexity of each of the pages is lower than a predetermined first reference value, the emulation selector selects PCL emulation or PostScript (PS) emulation,
in a case where the complexity of each of the pages is higher than the predetermined first reference value, the emulation selector selects PCL emulation or PS emulation if the speed of the printer controller is higher than a predetermined second reference value, and the emulation selector selects GDI emulation if the speed of the printer controller is lower than the predetermined second reference value.

9. A method of selecting and printing emulation by pages, the method comprising:
calculating a complexity of a document from an EMF of the whole document; and
selecting emulation to be printed based on the calculated complexity of each of pages and data obtained by measuring the performance of a printer controller.

10. The method of claim 9, wherein, in the calculating of the complexity, the complexity of each of pages of the document is evaluated.

11. The method of claim 10, further comprising; before the selecting of emulation, calculating the speed of the printer controller from the data obtained by measuring the performance of the printer controller,

12. The method of claim 10, wherein, in the calculating of the complexity, the complexity of each of the pages is evaluated by analyzing GDI functions included in each of the pages of the document from the EMF.

13. The method of claim 11, wherein the speed of the printer controller is calculated from data including time required for the printer controller to receive a PCL 6 command for expressing a vector graphic, and complete executing the PCL 6 command by a predetermined frequency that is received by a communication interfacer.

14. The method of claim 13, wherein the data obtained by measuring the
performance of the printer controller is transmitted/received and a bi-directional communication with the printer controller is performed.

15. The method of claim 11, wherein, in the selecting of emulation,
in case where the complexity of each of the pages is lower than a predetermined first reference value, PCL emulation or PS emulation is selected,
in case where the complexity of each of the pages is higher than the predetermined first reference value, PCL emulation or PS emulation is selected if the speed of the printer controller is higher than a predetermined second reference value, and GDI emulation is selected if the speed of the printer controller is lower than the predetermined second reference value.

16. A computer readable recording medium having embodied thereon a computer program for the method of selecting and printing emulation by pages, the method comprising:
calculating a complexity of a document from an EMF of the whole document; and
selecting emulation to be printed based on the calculated complexity of each of pages and data obtained by measuring the performance of a printer controller.

17. An apparatus to select and print emulation by pages, comprising:
a controller to receive information on an enhanced meta file (EMF) of a whole document and data obtained by measuring performance of a printer controller to be used in the printing, and to select the emulation to be printed base on a complexity of the EMF received and the data obtained by measuring performance of a printer controller.

18. The apparatus of claim 17, wherein the controller comprises:
a page analyzer to analyze graphical device interface (GDI) functions included in each of the pages of the document from the EMF and to evaluate the complexity of each of the pages;
a controller performance calculator to calculate the speed of the printer controller from the data obtained by measuring the performance of the printer controller; and
an emulation selector to select the emulation to be printed based on the analysis obtained by the page analyzer and the controller performance calculator.

19. A method of selecting and printing emulation by pages, the method comprising:
determining a complexity of a document from an enhanced meta file (EMF) of the whole document; and
selecting emulation to be printed based on the determined complexity of each of pages and data obtained by measuring the performance of a printer controller.

20. A computer readable recording medium having embodied thereon a computer program for the method of selecting and printing emulation by pages, the method comprising:
determining a complexity of a document from an enhanced meta file (EMF) of the whole document; and
selecting emulation to be printed based on the determined complexity of each of pages and data obtained by measuring the performance of a printer controller.
